(19) United States
(12) Patent Application Publication
(10) Pub. No.: US 2014/0372935 A1
(43) Pub. Date: Dec. 18, 2014

(54) Input Processing based on Input Context

(71) Applicant: Microsoft Corporation, Redmond, WA (US)

(72) Inventors: Bogdan Brinza, Bellevue, WA (US); Tyler M. Barton, Seattle, WA (US); Mike Pietraszak, Redmond, WA (US); Tony E. Schreiner, Bellevue, WA (US); Corey M. Bloodstein, Redmond, WA (US)

(21) Appl. No.: 13/918,840

(22) Filed: Jun. 14, 2013

(51) Int. Cl. G06F 3/0484

(52) U.S. Cl. CPC G06F 3/0484
USPC 715/781

(57) ABSTRACT

Techniques for input processing based on input context are described. In at least some embodiments, a region of a display area includes multiple graphic elements that can be generated and/or managed by different components. Examples of such components include applications, plug-in modules, graphics frameworks, and so forth. Techniques discussed herein enable input to graphical elements to be handled in various ways, such as by routing the input to an appropriate component. Further, custom input contexts can be specified such that particular types and/or combinations of inputs can be interpreted.

### BACKGROUND

Today's computing devices have access to a variety of visual content. For example, a web browsing application can display different types of content within an associated display area of a device. To enable visual content to be processed and displayed, an array of different graphics functionalities can be employed. Examples of such functionalities include rendering engines, graphics application programming interfaces (APIs), graphics editors, and so on.

While the availability of different graphics functionalities provides for a variety of options for processing and displaying visual content, enabling interaction between graphics functionalities presents challenges. For example, a display region may include visual content managed by different graphics functionalities. If a user provides input to a visual element of the display region, ensuring that the input is routed to the correct graphics functionality can be challenging. Further, complex inputs (e.g., touch-based gestures) that affect multiple display regions can be difficult to interpret utilizing current input routing techniques.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for input processing based on input context are described. In at least some embodiments, a region of a display area includes multiple graphic elements that can be generated and/or managed by different components. Examples of such components include applications, plug-in modules, graphics frameworks, and so forth. Techniques discussed herein enable input to graphical elements to be handled in various ways, such as by routing the input to an appropriate component. Further, custom input contexts can be specified such that particular types and/or combinations of inputs can be interpreted.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 illustrates an example implementation scenario in accordance with one or more embodiments.

FIG. 3 illustrates an example implementation scenario in accordance with one or more embodiments.

FIG. 4 illustrates an example implementation scenario in accordance with one or more embodiments.

FIG. 5 illustrates an example implementation scenario in accordance with one or more embodiments.

FIG. 6 is a flow diagram that describes steps in a method in accordance with one or more embodiments.

FIG. 7 is a flow diagram that describes steps in a method in accordance with one or more embodiments.

FIG. 8 illustrates an example system and computing device as described with reference to FIG. 1, which are configured to implement embodiments of techniques described herein.

### DETAILED DESCRIPTION

Overview

Techniques for input processing based on input context are described. In at least some embodiments, a region of a display area includes multiple graphic elements that can be generated and/or managed by different components. Examples of such components include applications, plug-in modules, graphics frameworks, and so forth. Techniques discussed herein enable input to graphical elements to be handled in various ways, such as by routing the input to an appropriate component.

For instance, consider a scenario in which a graphical user interface (GUI) for an application includes a primary window and a graphical element within the primary window. Examples of a graphical element include a banner, a control button, a menu, a Tillable field, and so forth. In at least some embodiments, the primary window of the GUI can be managed by a first component, while the graphical element within the primary window can be managed by a second component. In accordance with one or more embodiments, various input processing behaviors can be specified for handling input to the graphical element and/or the primary window, such as to which component the input is to be routed.

In at least some embodiments, an input contract can be generated for the first component and the second component. The input contract can specify various input processing behaviors that correspond to different input contexts that may occur. For instance, the input contract can specify to which component input to the graphical element is to be routed. As another example, the input contract can specify handling instructions for input that occurs to both the primary window and the graphical element, such as a multi-contact touch gesture that occurs both within the graphical element and outside of the graphical element within the primary window. Thus, an input contract can specify a variety of different input processing behaviors based on a variety of different input contexts.

In the following discussion, an example environment is first described that is operable to employ techniques described herein. Next, a section entitled “Example Implementation Scenarios” describes some example implementation scenarios in accordance with one or more embodiments. Following this, a section entitled “Example Procedures” describes some example methods in accordance with one or more embodiments. Finally, a section entitled “Example System and Device” describes an example system and device that are operable to employ techniques discussed herein in accordance with one or more embodiments.

Having presented an overview of example implementations in accordance with one or more embodiments, consider now an example environment in which example implementations may by employed.

### Example Environment

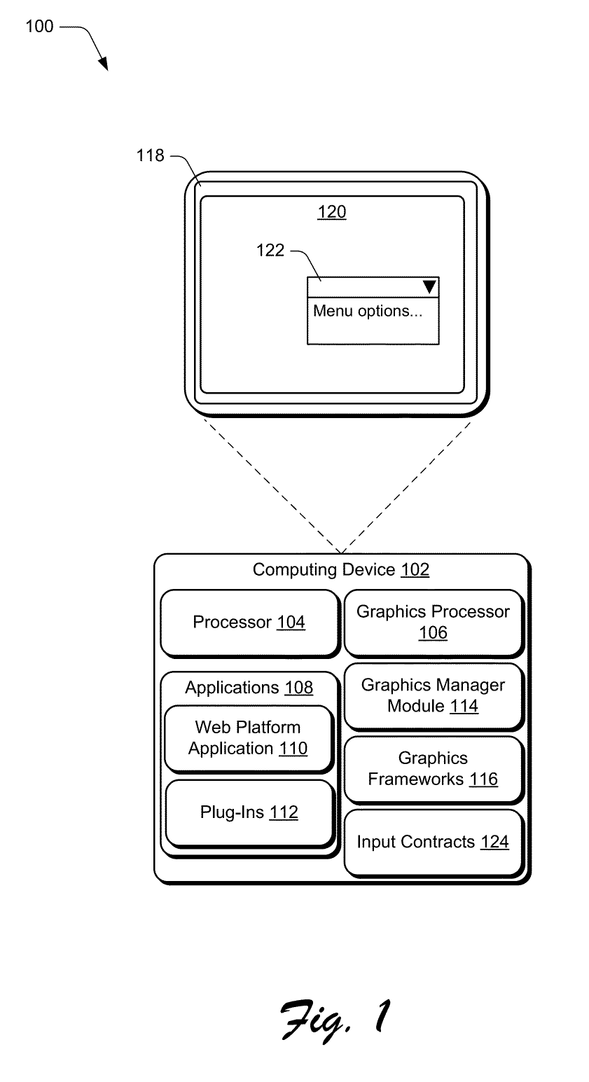

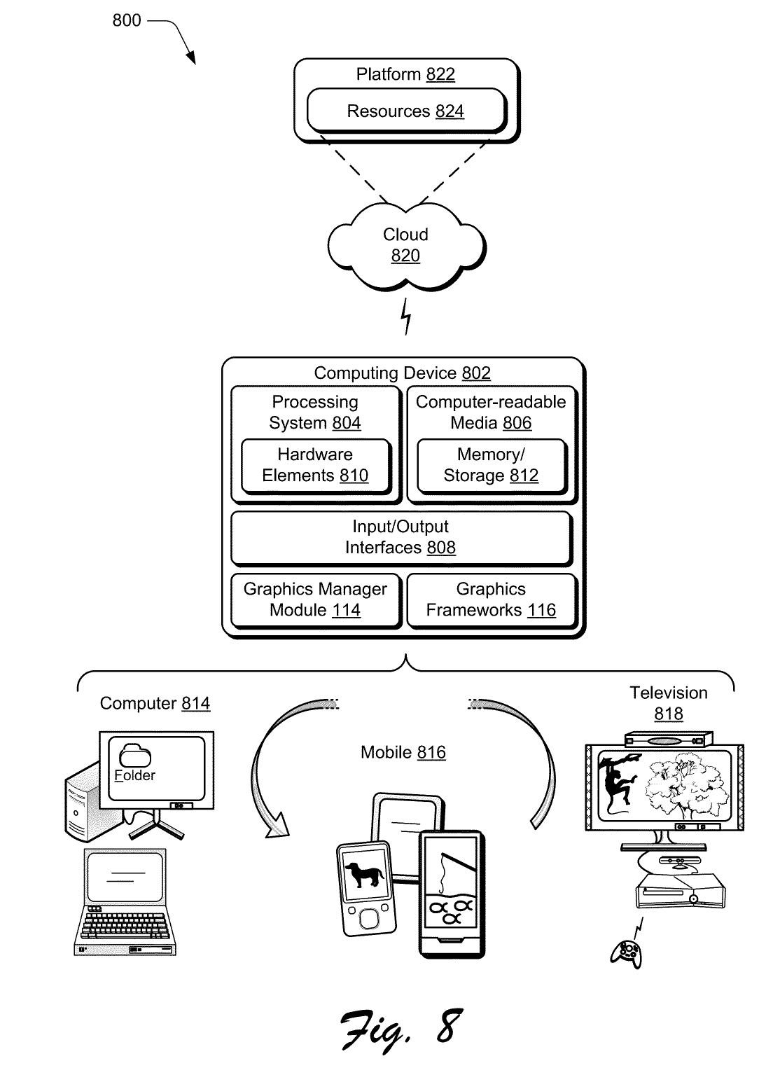

FIG. 1 is an illustration of an environment 100 in an example implementation that is operable to employ techniques for input processing based on input context described herein. The environment 100 includes a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device (e.g., a tablet), and so forth as further described in relation to FIG. 8.

Computing device 102 includes a processor 104, which is representative of functionality to perform various types of data processing for the computing device 102. For example, the processor 104 can represent a central processing unit (CPU) of the computing device 102. Further examples of implementations of the processor 104 are discussed below with reference to FIG. 8.

Further illustrated is a graphics processor 106, which is representative of functionality to perform various graphics-related tasks for the computing device 102. The graphics processor 106, for example, can represent a graphics processing unit (GPU) of the computing device 102.

The computing device 102 further includes applications 108, which are representative of functionalities to perform various tasks via the computing device 102. Examples of the applications 108 include a word processor application, an email application, a content editing application, a gaming application, and so on.

The applications 108 include a web platform application 110, which is representative of an application that operates in connection with web content. The web platform application 110, for example, can include and make use of many different types of technologies such as, by way of example and not limitation, uniform resource locators (URLs), Hypertext Transfer Protocol (HTTP), Representational State Transfer (REST), HyperText Markup Language (HTML), Cascading Style Sheets (CSS), JavaScript, Document Object Model (DOM), as well as other technologies. The web platform application 110 can also work with a variety of data formats such as Extensible Application Markup Language (XAML), Extensible Markup Language (XML), JavaScript Object Notation (JSON), and the like. Examples of the web platform application 110 include a web browser, a web application (e.g., “web app”), and so on. According to various embodiments, the web platform application 110 is configured to present various types of web content, such as webpages, web documents, interactive web content, and so forth.

The applications 108 further include plug-ins 112, which are representative of functionalities that extend the functionalities of the applications 108. The plug-ins, for instance, can add features to the applications 108, and/or enhance existing features of the applications 108.

A graphics manager module 114 is further included, which is representative of functionality to perform various tasks further to techniques for input processing based on input context discussed herein. The graphics manager module 114, for instance, can be implemented as a component of an operating system for the computing device 102. Embodiments, however, can employ a variety of different configurations and implementations of the graphics manager module 114. Further details concerning implementation of the graphics manager module 114 are discussed below.

The computing device 102 further includes graphics frameworks 116, which are representative of platforms for performing graphics processing for the computing device 102. Examples of the graphics frameworks 116 include a rendering engine, a graphics application programming interface (API), and so forth. The graphics frameworks 116 also include graphics-related languages and functionalities for processing the languages, such as Extensible Application Markup Language (XAML), Extensible Markup Language (XML), HyperText Markup Language (HTML), and so on. Thus, the graphics frameworks 116 generally represent graphics platforms that may be leveraged by various components (e.g., the applications 108) to enable graphics to be processed and/or displayed.

A display device 118 is also illustrated, which is configured to output graphics for the computing device 102. Displayed on the display device 118 is a window 120, which is representative of a graphic element generated and/or managed by a particular entity, such as one of the applications 108. For example, the window 120 can represent a GUI for a particular application. Further displayed is a graphical element 122, which is representative of a graphical element displayed within the window 120. In this example, the graphical element 122 represents a menu with selectable menu items. A wide variety of different types of graphics elements can be employed, however, in accordance with the claimed embodiments.

The computing device 102 further includes input contracts 124, which are representative of functionality to specify how input to various portions of the window 120 is handled among various components of the computing device 102. For instance, in at least some embodiments, different portions of the window 120 can be managed (e.g., generated) by different components of the computing device 102, such as different of the applications 108, the plug-ins 112, the graphics frameworks 116, and so forth. Accordingly, the input contracts 124 specify policies and/or rules for handling input among various components, such as to which components various inputs are to be routed, how different types of input are to be interpreted, and so forth.

According to one or more embodiments, an input contract enables input events to be understood by various components, such as various instances of the applications 108, the plug-ins 112, the graphics frameworks 116, and so forth. The input contracts 124, for instance, can enable input events to be converted between different input frameworks such that various components of the computing device 102 can understand the input events. For example, if a functionality of the computing device 102 (e.g., an input device driver, an operating system, and so on) generates an input event according to a particular input framework, an input contract associated with the input event can convert the input event into different forms such that different components can interpret the input event.

In at least some embodiments, different instances of the input contracts 124 can be specified for different portions of the window 120. For instance, one of the input contracts 124 can specify how input to the window 120 outside of the graphical element 122 is to be handled, and another of the input contracts 124 can specify how input inside of the graphical element 122 is to be handled. Yet another of the input contracts 124 can specify how input to both the window 120 and the graphical element 122 is to be handled. Thus, in at least some embodiments, different instances of the input contracts 124 can specify different groups of policies for handling different types of input and input to different portions of the window 120. Further implementations of the input contracts 124 are discussed below.

Having described an example environment in which the techniques described herein may operate, consider now some example implementation scenarios in accordance with one or more embodiments.

### Example Implementation Scenarios

The following discussion describes some example implementation scenarios for techniques for input processing based on input context described herein. The example implementation scenarios may be implemented in the environment 100 of FIG. 1, the system 800 of FIG. 8, and/or any other suitable environment.

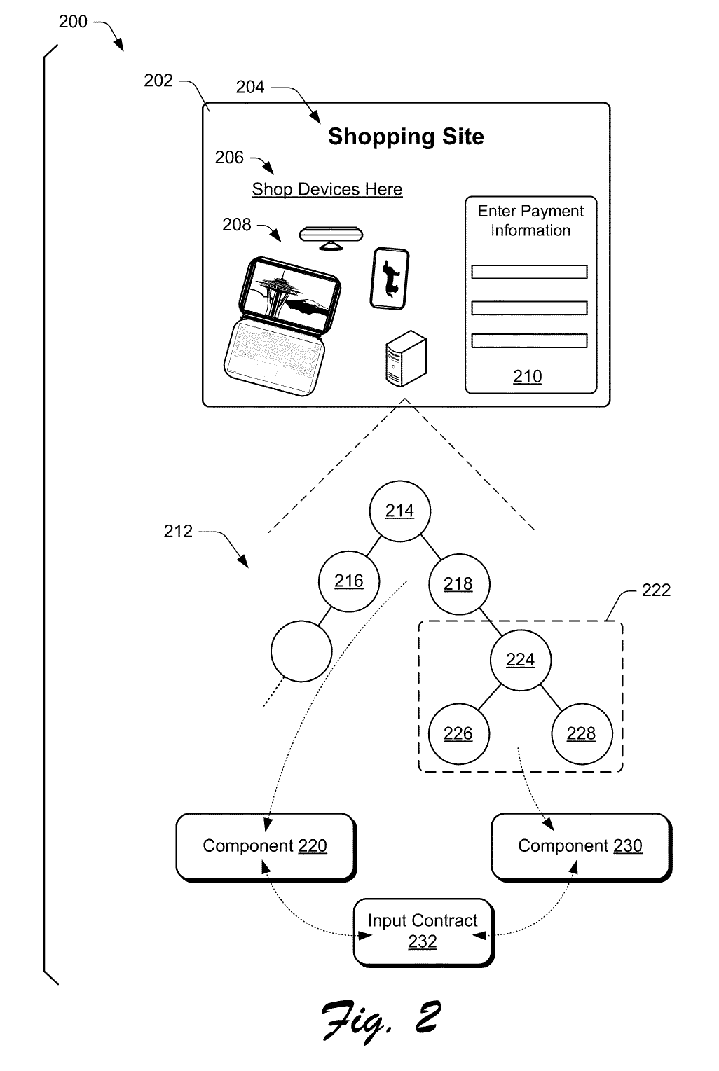

FIG. 2 illustrates an example implementation scenario 200 in accordance with one or more embodiments. The scenario 200 includes a graphical user interface (GUI) 202. The GUI 202, for example, may be displayed on the display device 118 by an application, a website, a web-based resource, and so forth. For instance, the GUI 202 can be presented via the web platform application 110. In this particular example, the GUI 202 is presented as part of a shopping website that enables a user to shop online for various goods and/or services.

The GUI 202 includes various visual elements, such as text, images, windows, and so forth. For instance, the GUI 202 includes a banner 204 that identifies a web resource associated with the GUI 202. The GUI 202 further includes a navigation element 206, which is selectable to present different content, such as via navigation to a different GUI. For instance, selecting the navigation element 206 can cause another webpage associated with the shopping website to be presented. The navigation element 206, for example, can represent a selectable hyperlink.

Further illustrated are graphics 208, which represent various graphical elements displayed as part of the GUI 202. Also displayed is a payment window 210, which includes various indicia that can receive payment information from a user. For instance, the payment window 210 includes finable fields in which a user can provide various information, such as a user name, shipping address, account information, credit card information, and so on. The payment window 210, for example, enables a user to provide information further to a purchase of goods and/or services via the GUI 202.

The visual elements included as part of the GUI 202 are presented for purpose of example only, and it is to be appreciated that a variety of different types and instances of visual elements can be implemented in accordance with various embodiments.

The scenario 200 further includes a tree structure 212, which is a data structure that represents various visual elements of the GUI 202. The tree structure 212, for instance, includes different nodes that correspond to respective visual elements of the GUI 202. For example, the nodes can represent graphics objects that correspond to visual elements of the GUI 202.

The tree structure 212 includes a root node 214, which represents the primary window of the GUI 202, e.g., the main window within which other visual elements of the GUI 202 are displayed. The tree structure 212 further includes a child node 216 which represents the navigation element 206, and a child node 218 which represents the graphics 208.

According to various embodiments, the root node 214 and the child nodes 216, 218 are managed by a component 220. The component 220, for example, is representative of a particular instance of the applications 108 and/or the graphics frameworks 116 discussed above. In at least some implementations, the component 220 is responsible for instantiating and managing the GUI 202.

The tree structure 212 further includes a node group 222, which represents the payment window 210. The node group 222, for instance, represents visual and/or functional elements of the payment window 210. The node group 222 includes a child node 224, which represents the payment window 210 as a whole. The node group 222 further includes a child node 226 and a child node 228, which represent sub-elements of the payment window 210. The child nodes 226, 228, for instance, represent different visual elements within the payment window 210, such as different fillable fields, selectable controls, and so forth.

The configuration and nodes of the tree structure 212 are presented for purpose of example only, and it is to be appreciated that different configurations and arrangements of data structures for representation of visual and/or functional elements can be employed in accordance with various embodiments.

According to one or more embodiments, the node group 222 is managed by a component 230. The component 230, for example, is representative of a particular instance of the applications 108, the plug-ins 112, and/or the graphics frameworks 116 discussed above. In at least some implementations, the component 230 is responsible for instantiating and managing the payment window 210 and its particular sub-elements. The component 230, for example, can generate the node group 222 and with permission from the component 220, append the nodes of the node group 222 to the tree structure 212 to enable the payment window 210 to be displayed as part of the GUI 202.

Thus, the component 220 and the component 230 represent different components which can manage (e.g., separately and/or independently) different visual and/or functional elements of the GUI 202.

According to various embodiments, techniques discussed herein enable interactions with (e.g., user input to) various visual elements of the GUI 202 to be routed to the appropriate component. For instance, input to visual elements managed by the component 220 (e.g., the banner 204, the navigation element 206, the graphics 208, and so forth) can be routed to and handled by the component 220. With reference to the tree structure 212, for example, input to nodes managed by the component 220 can be routed to and handled by the component 220. Similarly, input to visual elements managed by the component 230 (e.g., the payment window 210) can be routed to and handled by the component 230.

Further to such embodiments, the scenario 200 includes an input contract 232, which is representative of functionality to specify how input to various portions of the GUI 202 is handled among various components. The input contract 232, for example, can specify that input to the payment window 210 is to be routed to the component 230. The input contract 232 can further specify that input to the payment window 210 is not to be routed to the component 220, e.g., is to be prevented from being accessed by the component 220. Thus, sensitive information can be protected from being accessed by untrusted and/or unverified processes. In at least some embodiments, the input contract 232 can be linked to particular nodes of the tree structure 212 to specify how input to those nodes is to be handled.

Accordingly to various embodiments, an input contract can be employed when routing input to various components. For instance, consider the following example implementation scenario.

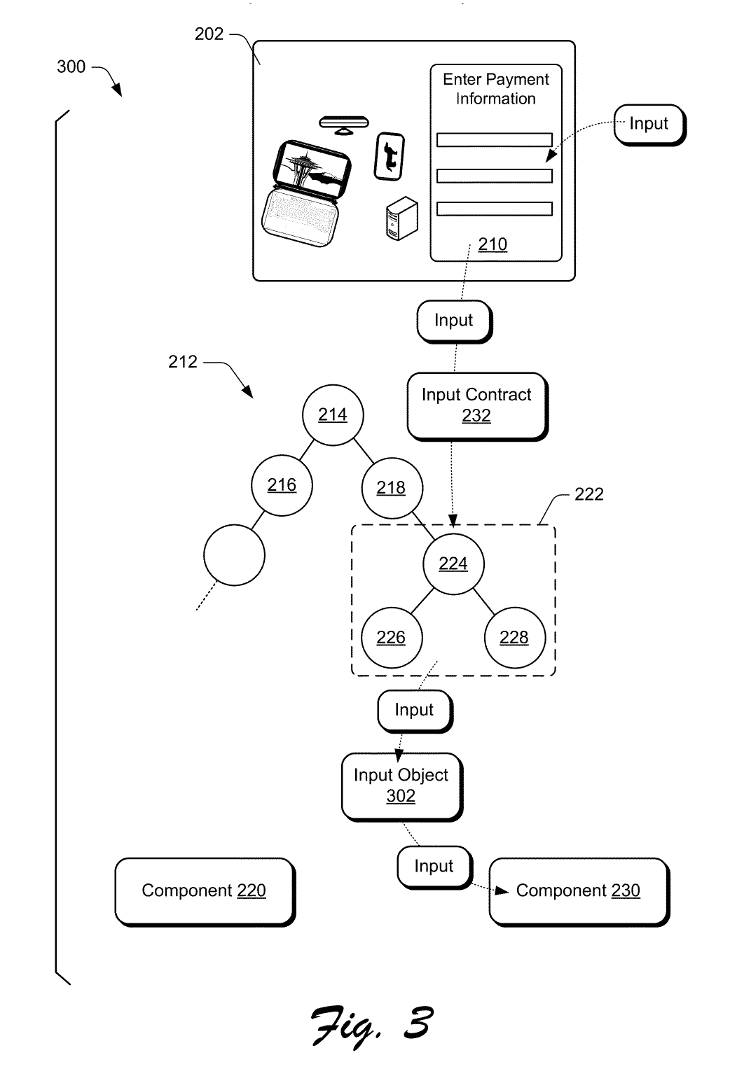

FIG. 3 illustrates an example implementation scenario 300 in accordance with one or more embodiments. The scenario 300 includes the GUI 202 with the payment window 210, and the tree structure 212, introduced above in the discussion of FIG. 2.

Further to the scenario 300, consider that a user provides input to the payment window 210. For instance, the user can provide various types of payment-related information to fields included in the payment window 210. The input is processed based on the input contract 232. The input contract 232, for example, specifies that the input is to be routed to the component 230. The component 230 can be associated with a web-based payment processor, which can perform various processing tasks on the input as part of a purchase of goods and/or services.

In at least some embodiments, policies included in the input contract 232 specify that input to the node group 222 is to be routed to the component 230, while such input is not to be routed to the component 220. For example, input to the node group 222 can be routed to the component 230 without being passed further up the tree structure 212, e.g., to other nodes outside of the node group 222. Further, input to nodes outside of the node group 222 (e.g., the nodes 214, 216, 218) can be routed to the component 220 without being routed to and/or exposed to the component 230.

In one or more embodiments, the input contract 232 can further specify that input to the payment window 210 is to be protected such that the input cannot be accessed by the component 220 and/or other functionalities besides the component 230. Protecting such input can enhance data security, such as by preventing unauthorized and/or malicious access to data. In some alternative embodiments, however, input to the node group 222 can be routed to multiple components, e.g., both the component 220 and the component 230.

To enable input to the payment window 210 to be routed to the component 230, the scenario 300 includes an input object 302. Generally, the input object 302 is a data structure (e.g., a component object model (COM) object) that can be linked to various graphical elements such that input to the graphical elements can be appropriately routed.

In at least some embodiments, the input object 302 includes and/or is associated with functionality that routes the input to an appropriate component. The input object 302 can be generated by and/or managed by various entities, such as the component 230, the applications 108, the graphics manager module 114, and so forth. Thus, an input object can be used to create a custom input channel such that input to graphical elements can be routed to various functionalities and/or locations, such as graphics frameworks, applications, services, memory locations, and so on.

According to one or more embodiments, the input object 302 can be linked to the payment window 210 via an identifier for the payment window 210, e.g., an identifier generated by the component 230 for the payment window 210. Alternatively or additionally, the input object 302 can be linked to the payment window 210 by being associated with a display region (e.g., a pixel region) in which the payment window 210 is displayed. For instance, instead of “window based” input routing, techniques discussed herein can employ “visual based” input routing that routes input based on association with a pixels associated with a graphical element.

According to various embodiments, the input contract 232 can specify that input to the payment window 210 is to be routed via the input object 302. For example, the input contract 232 can identify the input object 302 as a routing mechanism for input to the payment window 210.

In at least some embodiments, the input contract 232 can specify how different types of input are to be interpreted based on the type of input and/or the regions of the GUI 202 in which the input is received. For instance, consider the following example scenarios.

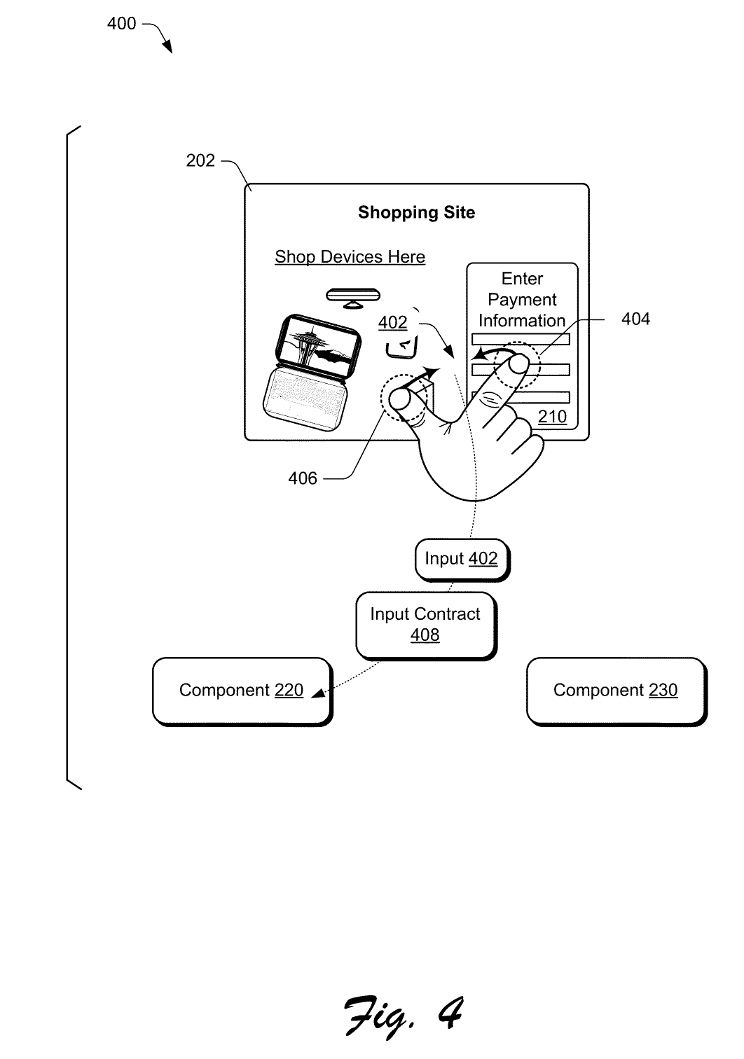

FIG. 4 illustrates an example implementation scenario 400 in accordance with one or more embodiments. The scenario 400 includes the GUI 202 with the payment window 210. As discussed above, input to the payment window 210 is typically routed to the component 230, while input to the GUI 202 outside of the payment window 210 is typically routed to the component 220. For instance, input to various regions of the GUI 202 can be routed via input objects associated with the respective regions.

In at least some embodiments, inputs that affect multiple regions of a display area can be processed based on an input contract between the regions. For example, in the scenario 400, a user provides an input 402 to the GUI 202. The input 402 represents a two-finger touch gesture on the GUI 202, such as detected via touchscreen functionality of the computing device 102. The input 402, for instance, can correspond to a pinch gesture on the GUI 202.

As illustrated, an input portion 404 of the input 402 occurs within the payment window 210, while an input portion 406 of the input 402 occurs outside of the payment window 210. Accordingly, an input contract 408 between the component 220 and the component 230 specifies that when input is received both outside and inside of the payment window 210 in the GUI 202, specific input processing policies are to be applied. The input contract 408, for instance, can specify that an input that includes portions both inside and outside of the payment window 210 is to be routed to the component 220 as a combined input.

With reference to the input 402, the input can be interpreted as a pinch gesture on the GUI 202 that includes both the input portion 404 and the input portion 406. Thus, the input 402 can be routed to the component 220 for processing. The component 220, for instance, can interpret the input 402 has a zoom gesture, and can thus cause a zoom operation to be performed on the GUI 202 as a whole.

Accordingly, in at least some embodiments, the input 402 is not interpreted as two separate inputs, e.g., the input portion 404 to the payment window 210, and the separate input portion 406 outside of the payment window 210. Instead, a context of the input 402 is interpreted according to the input contract 408 as a single integrated input, and is routed accordingly.

The input 402 is presented for purposes example only, and it is to be appreciated that a wide variety of forms and types of inputs can be recognized and processed according to techniques discussed herein.

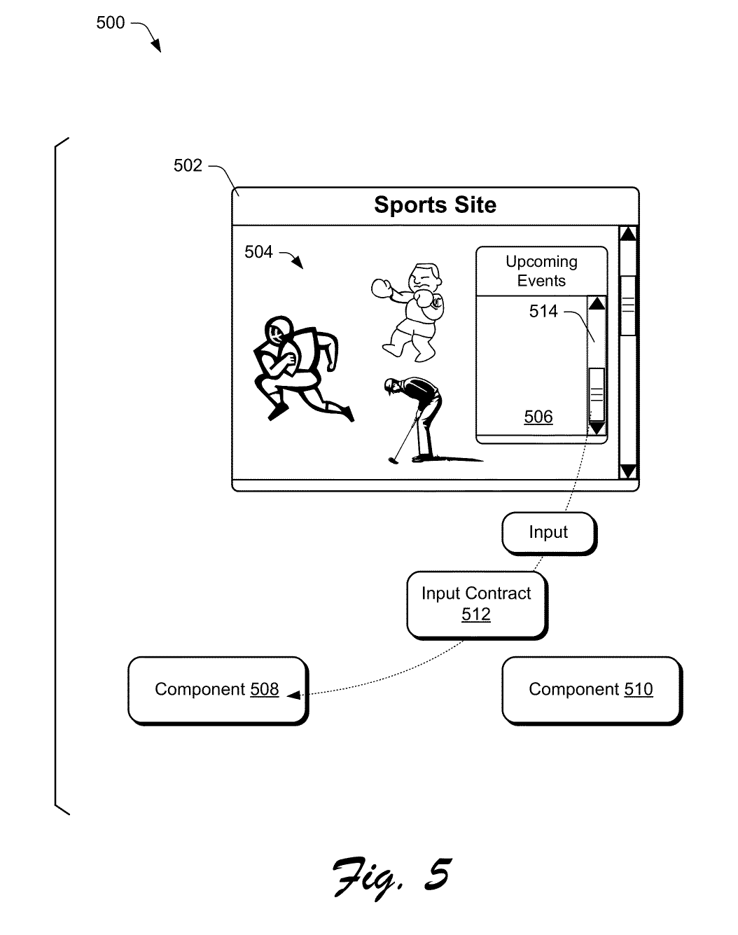

FIG. 5 illustrates an example implementation scenario 500 in accordance with one or more embodiments. The scenario 500 includes a GUI 502, which includes a primary window 504 and an interior window 506. The primary window 504 is managed by a component 508, and the interior window 506 is managed by a component 510. The components 508, 510, for instance, are representative of respective instances of the applications 108, the plug-ins 112, the graphics frameworks 116, and so forth.

In at least some embodiments, input to the primary window 504 can be routed to the component 508, and input to the interior window 506 can be routed to the component 510. An input contract 512 between the components 508, 510 specifies that in certain circumstances, input can be shared and/or transferred between the respective components.

For instance, consider that a user is scrolling within the interior window 506, such as via a scroll bar 514. The input contract 512 can specify that when a scroll operation within the interior window 506 reaches an upper or lower boundary of the interior window 506 and scrolling input continues, scrolling of the primary window 504 can be initiated. Thus, the input contract 512 can indicate a scrolling input handoff between the component 510 and the component 508. For example, when scrolling within the interior window 506 reaches an upper or lower boundary of the interior window 506 and scrolling input continues, the scrolling input can be redirected from an input object for the component 510, to an input object for the component 508.

Similarly, panning the interior window 506 to a rightmost or leftmost boundary can initiate panning of the primary window 504. Thus, in at least some embodiments, navigating the interior window 506 to a particular boundary can initiate navigation (e.g., scrolling, panning, and so forth) of the primary window 504.

Accordingly, as illustrated in the scenarios above, custom input routing channels can be generated. Further, custom input contexts can be specified such that particular types and/or combinations of inputs can be interpreted.

Having discussed some example implementation scenarios, consider now a discussion of some example procedures in accordance with one or more embodiments.

### Example Procedures

The following discussion describes some example procedures for input processing based on input context in accordance with one or more embodiments. The example procedures may be employed in the environment 100 of FIG. 1, the system 800 of FIG. 8, and/or any other suitable environment.

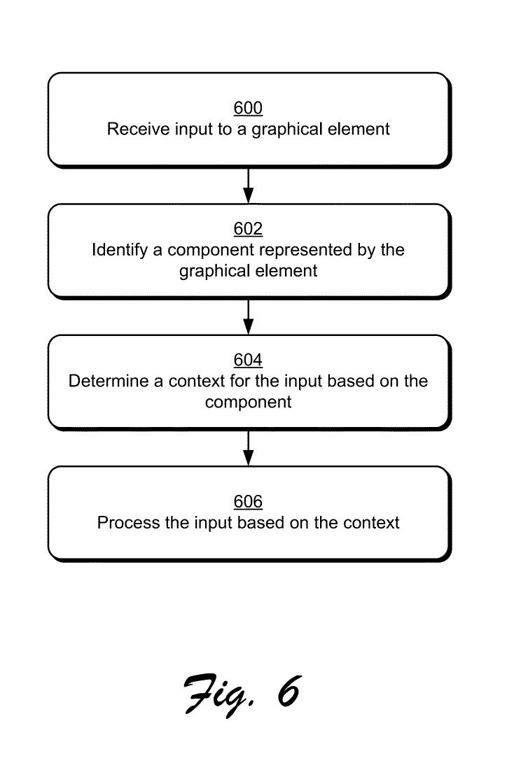

FIG. 6 is a flow diagram that describes steps in a method in accordance with one or more embodiments. Step 600 receives input to a graphical element. Various types of user input can be received, examples of which are discussed above and below. A graphical element can include various visual representations, such as a window, an image, text, and so forth, displayed in a region of a display. The graphical element, for example, can include at least a portion of a GUI.

Step 602 identifies a component represented by the graphical element. Examples of a component include instances of the applications 108, the plug-ins 112, the graphics frameworks 116, and so forth. In at least some embodiments, the component can be identified by identifying a pixel region in which the input was received, and then determining which component is represented in the pixel region. According to one or more embodiments, a portion of a display region in which an input is received can be identified on a pixel-by-pixel basis. Thus, a component for the portion of the display region can be identified by correlating a pixel region to the component, and not simply based on a window of a display region associated with the component.

Step 604 determines a context for the input based on the component. The context, for example, may refer to which component is represented by a pixel region in which input is received.

According to various embodiments, a “context” for an input can refer to ways in which the input is to be interpreted, and/or components to which the input is to be routed. As discussed above and below, a context can be determined based on an input contract for a component and/or components represented by a display region in which input is received.

Step 606 processes the input based on the context. Processing the input, for example, can include routing the input to the component associated with the portion of the display region, and/or a different component based on an input contract. As discussed below, processing the input may include adding context information to the input to drive interpretation of the input by a component.

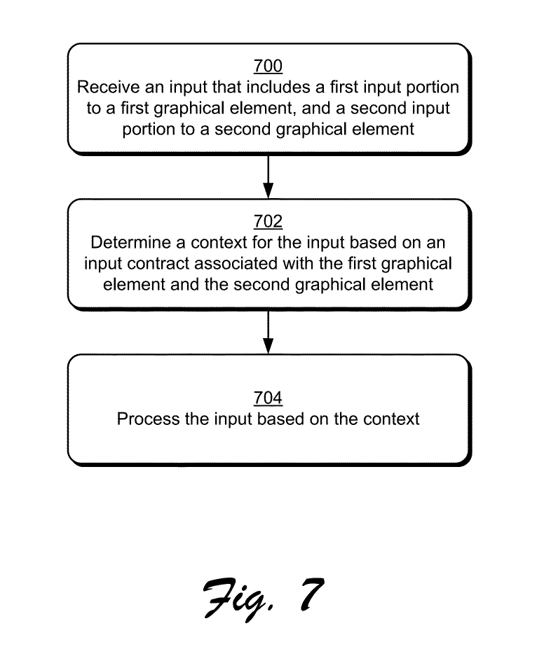

FIG. 7 is a flow diagram that describes steps in a method in accordance with one or more embodiments. Step 700 receives an input that includes a first input portion to a first graphical element, and a second input portion to a second graphical element. As discussed above, for example, an input can touch and/or affect multiple portions of a display region, such as multiple regions, multiple windows, multiple graphical images, and so forth. In at least some embodiments, the first graphical element and the second graphical element can be managed by different components, such as different applications, plug-ins, and so forth.

Examples of such inputs include multi-contact touch gestures, touchless gestures (e.g., as detected by a camera), and so forth. Such inputs may also include single-contact touch gestures, such as various types of swipe gestures that contact multiple graphical elements. Such inputs may further include combinations of different forms of inputs, such as a keyboard input combined with a mouse input, a pen input combined with a touch input, and combinations of various other types of inputs.

Step 702 determines a context for the input based on an input contract associated with the first graphical element and the second graphical element. As discussed above, an input contract can specify parameters for how inputs that affect multiple graphical elements (e.g., regions of a display) are to be handled.

For instance, in embodiments where the first graphical element and the second graphical element are managed by different components, the input contract can specify to which component the input is to be routed. Additionally or alternatively, the input contract may specify how the input is to be interpreted, such as by mapping various combinations of input portions to specific commands. For instance, different combinations of inputs can cause different actions to occur. Thus, an input contract can specify that for a particular combination of inputs (e.g., as detected at different graphical elements), a particular action is to occur.

Step 704 processes the input based on the context. Processing the input, for example, can include routing the input to a component for the first graphical element and/or the second graphical element. In at least some embodiments, the input can be routed with context information that indicates to a component how the input is to be interpreted, processed, and so forth. Context information, for example, can specify that the input requests a zoom operation on a main window, that the input requests that the window be panned in a particular direction, that the input is to be protected from access by other components, and so forth. Thus, context information can provide parameters by which a component that receives the input is to interpret and/or handle the input. In at least some embodiments, the input contract determined for the input can include the context information.

Having discussed some example procedures, consider now a discussion of an example system and device in accordance with one or more embodiments.

### Example System and Device

FIG. 8 illustrates an example system generally at 800 that includes an example computing device 802 that is representative of one or more computing systems and/or devices that may implement various techniques described herein. For example, the computing device 102 discussed above with reference to FIG. 1 can be embodied as the computing device 802. The computing device 802 may be, for example, a server of a service provider, a device associated with the client (e.g., a client device), an on-chip system, and/or any other suitable computing device or computing system.

The example computing device 802 as illustrated includes a processing system 804, one or more computer-readable media 806, and one or more Input/Output (I/O) Interfaces 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 806 is illustrated as including memory/storage 812. The memory/storage 812 represents memory/storage capacity associated with one or more computer-readable media. The memory/storage 812 may include volatile media (such as random access memory (RAM)) and/or nonvolatile media (such as read only memory (ROM), Flash memory, optical disks, magnetic disks, and so forth). The memory/storage 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Thus, computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 810 and computer-readable media 806 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of modules that are executable by the computing device 802 as software may be achieved at least partially in hardware, e.g., through use of computer-readable storage media and/or hardware elements 810 of the processing system. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 802 may assume a variety of different configurations, such as for computer 814, mobile 816, and television 818 uses. Each of these configurations includes devices that may have generally different constructs and capabilities, and thus the computing device 802 may be configured according to one or more of the different device classes. For instance, the computing device 802 may be implemented as the computer 814 class of a device that includes a personal computer, desktop computer, a multi-screen computer, laptop computer, netbook, and so on.

The computing device 802 may also be implemented as the mobile 816 class of device that includes mobile devices, such as a mobile phone, portable music player, portable gaming device, a tablet computer, a multi-screen computer, and so on. The computing device 802 may also be implemented as the television 818 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein. For example, functionalities discussed with reference to the graphics manager module 114 and/or the graphics frameworks 116 may be implemented all or in part through use of a distributed system, such as over a “cloud” 820 via a platform 822 as described below.

The cloud 820 includes and/or is representative of a platform 822 for resources 824. The platform 822 abstracts underlying functionality of hardware (e.g., servers) and software resources of the cloud 820. The resources 824 may include applications and/or data that can be utilized while computer processing is executed on servers that are remote from the computing device 802. Resources 824 can also include services provided over the Internet and/or through a subscriber network, such as a cellular or Wi-Fi network.

The platform 822 may abstract resources and functions to connect the computing device 802 with other computing devices. The platform 822 may also serve to abstract scaling of resources to provide a corresponding level of scale to encountered demand for the resources 824 that are implemented via the platform 822. Accordingly, in an interconnected device embodiment, implementation of functionality described herein may be distributed throughout the system 800. For example, the functionality may be implemented in part on the computing device 802 as well as via the platform 822 that abstracts the functionality of the cloud 820.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

### CONCLUSION

Techniques for input processing based on input context are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
at least one processor; and
one or more computer-readable storage media including instructions stored thereon that, responsive to execution by the at least one processor, cause the system to implement functionalities including:
a graphical user interface (GUI) including a primary window and a graphical element within the primary window; and
at least one module configured to process input to the graphical element based on an input contract between a first component represented by the primary window, and a second component represented by the graphical element.

2. A system as recited in claim 1, wherein the first component is an instance of an application, a plug-in, or a graphics framework, and wherein the second component is a different instance of an application, a plug-in, or a graphics framework.

3. A system as recited in claim 1, wherein the first component comprises a web platform application, and the second component comprises a plug-in to the web platform application.

4. A system as recited in claim 1, wherein the input contract specifies that input to the graphical element is to be routed to the second component.

5. A system as recited in claim 1, wherein the input contract specifies that input to the graphical element is to be protected from being accessed by the first component.

6. A system as recited in claim 1, wherein the input contract specifies that if an input includes an input portion to the graphical element and an input portion to the primary window, the input is to be routed to the first component.

7. A system as recited in claim 1, wherein the input contract specifies one or more circumstances in which input is to be transferred between the first component and the second component.

8. A system as recited in claim 1, wherein the graphical element comprises an interior window, and wherein the input contract specifies that if the interior window is navigated to a boundary of the interior window, navigation of the primary window is to be initiated.

9. One or more computer-readable storage media comprising instructions stored thereon that, responsive to execution by a computing device, cause the computing device to perform operations comprising:
receiving an input that includes a first input portion to a first graphical element, and a second input portion to a second graphical element; and
determining a context for the input based on an input contract associated with the first graphical element and the second graphical element; and
processing the input based on the context.

10. One or more computer-readable storage media as recited in claim 9, wherein the first graphical element comprises a primary window of a graphical user interface (GUI), and the second graphical element comprises a graphical element within the primary window.

11. One or more computer-readable storage media as recited in claim 9, wherein the first graphical element is managed by a first component, the second graphical element is managed by a second component, and wherein the context specifies that the input is to be routed as a single input event to one of the first component or the second component.

12. One or more computer-readable storage media as recited in claim 9, wherein the first graphical element comprises a primary window managed by a first component, the second graphical element comprises a graphical element within the primary window managed by a second component, and wherein the context specifies that the input is to be routed as a single input event to the first component.

13. One or more computer-readable storage media as recited in claim 9, wherein the input comprises a multi-contact touch gesture.

14. A computer-implemented method, comprising:
receiving input to a graphical element;
identifying a component represented by the graphical element by correlating a pixel region for the graphical element to the component; and
processing the input according to a context determined based on the component.

15. A method as described in claim 14, wherein the component comprises one of an application, a plug-in, or a graphics framework that generates the graphical element, and wherein said processing comprises routing the input to the component.

16. A method as described in claim 14, wherein the graphical element is displayed within a window managed by a different component, the method further comprising determining the context based on an input contract between the component and the different component.

17. A method as described in claim 16, wherein the input contract specifies whether the input is to be routed to the component or the different component.

18. A method as described in claim 16, wherein the input contract specifies that the input is to be routed to the component and not to the different component.

19. A method as described in claim 14, wherein the context specifies how the input is to be interpreted by the component.

20. A method as described in claim 14, wherein the input includes a first input portion to the graphical element, and a second input portion to a different graphical element managed by a different component, and wherein the context indicates that the input is to be routed to one of the component or the different component as a single input event.
